(19) United States
(12) Patent Application Publication
(10) Pub. No.: US 2022/0373817 A1
(43) Pub. Date: Nov. 24, 2022

(54) Directional Backlit Type Display Device

(71) Applicant: E-LEAD ELECTRONIC CO., LTD., Changhua (TW)

(72) Inventor: Stephen CHEN, Changhua (TW)

(21) Appl. No.: 17/465,371

(22) Filed: Sep. 2, 2021

(30) Foreign Application Priority Data
May 20, 2021 (TW) 110118165

(51) Int. Cl. G02B 30/33; G02B 27/01

(52) U.S. Cl. CPC G02B 30/33; G02B 27/0101; G02B 2027/0134

(57) ABSTRACT

A directional backlit type display device comprises a backlight provided with a light source module, a reflective narrow-angle diffuser provided with an array of a plurality of micro-curved mirrors reflecting the light and uniformly diffusing the light with a narrow diffusion angle, the backlit type display panel being configured on a projecting path where the reflective narrow-angle diffuser reflecting the light to an observer, the backlit type display panel displaying an image projected to an eye box of the observer by the reflected light, at least one of the micro-curved mirrors of the reflective narrow-angle diffuser corresponding to each pixel of the image, uniformly diffusing the light of each pixel to the eye box of the observer, the diffusion areas of all pixels on the backlit type display panel superimpose on the eye box of the observer.

### BACKGROUND

### Technical Field

The present disclosure is directed to a directional backlit type display device, which projects a light to a reflective narrow-angle diffuser with an array of micro-curved mirrors, and then reflects light toward a preset direction with narrow diffusion angle to generate a uniform directional light beam served as a backlight for the directional backlit type display device.

### Related Art

Please refer to FIG. 1, TFT-LCD (Thin Film Transistor-Liquid Crystal Display) panel is the most common back-lit type display panel comprises a backlight 91, a liquid crystal molecule layer 92 being configured between two parallel glass substrates, two polarizers 93 with orthogonal polarization at both outer sides. The lower glass substrate provided with a thin-film transistor (TFT) array 94. The upper glass substrate provided with a color filter (CF). The orientation of liquid crystal molecules controlled by the electric field generated from driving signal of TFT. The light from the backlight partially passes through the first polarizer, and the polarizing direction of the first polarizer is perpendicular to the polarizing direction of the second polarizer, therefore the light is blocked by the second polarizer. If the light passing through the first polarizer is rotated by the crystal molecules for changing the polarizing direction, then the light passes through the second polarizer and display the preset brightness and color of pixels.

Please refer to FIG. 2, an ideal directional liquid crystal display (LCD) 96, the scattered light from each pixel of the liquid crystal panel reached every point of an eye box Z for the observer with identical brightness, and vice versa, each point of the eye box receives the light from each pixel of the liquid crystal panel with equal brightness. The observer sees a full image while eyes of the observer are in any position within the eye box Z. On the other hand, the observer can't see any image at all while eyes of the observer are outside of the eye box Z.

Each pixel on the liquid crystal panel of a liquid crystal display is usually composed of sub-pixels in three colors, red, green, and blue (RGB). By the intensity of the electric field, the rotation angle of the liquid crystal molecules in sub-pixels is controlled, enabling the luminous intensity of the sub-pixels to be controlled. By controlling the proportion of the three colors RGB in each pixel, the brightness and color of the pixel are defined. Nevertheless, each sub-pixel equals to a slit causing the light to pass through each sub-pixel diffracted. Please refer to FIG. 3A, when a slit width W1 is much larger than the light wavelength λ, the diffraction is not obvious. Please refer to FIG. 3B, when a slit width W2 is similar to the light wavelength λ, the diffraction is obvious. The RGB sub-pixels are usually rectangular as shown in FIG. 4A, one side is a long edge, and the other side is a short edge. The sub-pixels are laid out in an orthogonal array, that is, the long edge of each sub-pixel is parallel to a vertical direction of FIG. 4A, the short edge of each sub-pixel being corresponded to a horizontal width Wₛₚₕ and the long edge of each sub-pixel being corresponded to a vertical width Wₛₚᵥ. Thus, the diffraction in the horizontal direction is more obvious than the diffraction in the vertical direction. The light projection area where after the light passing through the liquid crystal panel exceeds the preset projection area. That is to say, the image can be seen outside the eye box in the horizontal direction. The smaller the horizontal width Wₛₚₕ, the more obvious the diffraction is.

The backlight of liquid crystal displays (LCDs) deploys visible light sources such as an incandescent light bulb, a cold cathode fluorescent lamp (CCFL), an electroluminescence (EL), a light-emitting diode (LED), etc. Based on light sources distribution, it is divided into edge-lit and direct-lit (back-lit) type.

A direct-lit type uses an area light source, it is a continuously uniform surface light source, such as EL or flat fluorescent lamp, or it is defined by a plurality of point lights, such as an LED array.

LED backlights have benefits of uniform brightness, long lifetime, low-voltage driving, no inverter needed, wide color gamut and thus become mainstream deployed in liquid crystal displays.

Please refer to FIG. 5A, a direct-lit type backlight comprises an LED array provided with a light guide 97 and a diffuser 98 to modify light emission direction and diffusion angle, so as to increase front brightness and diffuse light uniformly.

The aforementioned direct-lit (back-lit) type backlight doesn't have directivity. Applications require directional backlight, for example, a projector or a head-up display (HUD), LEDs are provided with a cup-shaped collimating lens 99 on above of LED, as shown in FIG. 5B, to improve light utilization and increase directivity of emitted light.

Please refer to FIG. 6, a backlight 91 is a collimated LED array which comprises a plurality of LEDs with collimating lens on the above of each LED arranged in a vertical and horizontal direction to achieve the purpose of area light source.

However, gaps between adjacent collimating lens become darker blocks (shadows) in the whole area light source. Each collimating lens has difference in brightness at the center and an edge thereof, causing uneven brightness of the area light source. Besides, the collimated light emitted from the collimating lens is unable to uniformly diffuse the light to every position of the eye box after passing through each pixel of the liquid crystal panel.

Please refer to FIG. 7, in order to perform a uniform light emission from the collimated LED array backlight, a diffuser 98 is configured between a backlit type display panel and the array of collimating lenses to uniformly diffuse the light. However, the effectiveness of the diffuser is limited, unable to achieve a uniform area light source; furthermore, causing light attenuation and temperature rising.

Please refer to FIG. 8, a reflective narrow-angle diffuser is included in a projector (LCD, DLP or Laser projector) to reflect and diffuse the projected image light to the eye box of an observer, improving light utilization and increasing image brightness. The reflective narrow-angle diffuser reflects and uniformly diffuses light of each pixel in the projected image to every position of the eye box of the observer.

Please refer to FIG. 9A, the reflective narrow-angle diffuser comprises a plurality of micro-concave mirrors 21 laid out in an array, aligned in square or hexagonal honeycomb. Each micro-concave mirror 21 sizes in a range of 2.5 μm˜0.25 mm.

Each micro-concave mirror 21 is provided with identical or non-identical curvatures and angles.

The quantity of the micro-concave mirrors of the reflective narrow-angle diffuser could be any number depending on resolutions and optical paths design requirement, for example, hundreds of thousands (480p: 640×480=307,200; 720p: 1280×720=921,600), millions (FHD: 1920×1080=2.073,600; 2K: 2560×1440=3,680,400, 4K: 3840×2160=8,294,400), or even more.

Please refer to FIG. 9B, the reflective narrow-angle diffuser is a flat surface or a curved surface provided with a plurality of micro-concave mirrors 21 at a side thereof.

Please refer to FIG. 10A, an ordinary flat reflector with smooth surface, the incident angle of the incident light is equals to the reflection angle of the reflected light, hence without effectiveness of diffusion, the diffusion angle of the light maintaining the same, therefore viewing angles is limited.

Please refer to FIG. 10B, a projection curtain with flat surface. In order to allow observers of each angle to see the projected image, surface scattering is needed, the light projected to the flat surface is scattered in all directions (i.e., a diffusion angle is θ1), thereby substantially reducing brightness of the image seen by the observers.

Please refer to FIG. 10C, the micro-concave mirrors of the reflective narrow-angle diffuser could reflect an incident light toward a preset direction with the narrow angle diffusion, therefore substantially increasing brightness in the range of a diffusion angle θ2.

### SUMMARY

The present disclosure is directed to a directional backlit type display device comprises the following.

A light source module projects a light.

A reflective narrow-angle diffuser comprises a plurality of micro-curved mirrors laid out in an array. The reflective narrow-angle diffuser reflects the light and uniformly diffuses the light with a narrow diffusion angle.

A backlit type display panel is configured on a projecting path where the reflective narrow-angle diffuser projects the light to an observer. An image displayed on the backlit type display panel is projected to a projection area (i.e., an eye box of the observer) by the light. Each pixel of the image is corresponded to at least one of the micro-curved mirrors on the reflective narrow-angle diffuser. The light passing through each pixel can be uniformly diffused to the projection area. Light projection angle and diffusion angle corresponding to each pixel is adjusted by the reflective narrow-angle diffuser to superimpose all the diffusion areas on the same projection area. Hundreds of thousands and millions of pixels on the backlit type display panel all have the same diffusion situation.

Under such an arrangement, the light reflected by the reflective narrow-angle diffuser is projected to the backlit type display panel with uniform diffusion and it is not necessary to install a light homogenizer on the optical path.

The sub-pixels of each pixel on the backlit type display panel are arranged with the long edges of the sub-pixels perpendicular to the up-down direction (i.e., the vertical direction) of the backlit type display panel, which reduces the diffraction phenomenon in the horizontal direction.

In some embodiment, the plurality of micro-curved mirrors of the reflective narrow-angle diffuser are micro-concave mirrors, micro-convex mirrors, or a combination of micro-concave mirrors and micro-convex mirrors. The reflective narrow-angle diffuser is configured to define sizes, brightness, and location of the projection area.

In some embodiment, a plano-convex cylindrical lens or a biconvex cylindrical lens is further included between the reflective narrow-angle diffuser and the light source module to shape the circular projection area of the light source module into an elliptical shape, which is similar to a rectangular eye box.

In some embodiment, a plano-convex lens or a biconvex lens, that is, lenses with curvature in both axial directions, is further included between the reflective narrow-angle diffuser and the light source module to shape the circular projection area of the light source module into an approximate rectangular shape, which is more similar to a rectangular eye box.

In some embodiment, at least a reflector is included between the reflective narrow-angle diffuser and the light source module to fold the optical path and make the use of space more flexible.

In some embodiment, the light source module is a high power LED, an LED array, an LED with collimating lens, or a collimated LED array.

In some embodiment, the light source module is configured to define sizes, brightness, and location of the projection area.

In some embodiment, the image light projection path of the backlit type display panel further includes a concave mirror and a windshield. The image light is reflected and magnified by the concave mirror and the windshield before being projected to the eye box of the viewer.

In some embodiment a directional backlit type autostereoscopic display device is disclosed, comprising a plurality of light source modules, at least two light source modules projecting a first light and a second light respectively, a reflective narrow-angle diffuser reflecting the first light and the second light, and uniformly diffusing the first light and the second light with a narrow diffusion angle respectively-, a backlit type display panel alternately displaying a left-eye parallax image and a right-eye parallax image in a time-multiplexed manner. The first light source module and the second light source module alternately project the first light and the second light. When the first light and the second light pass through the backlit display panel, the left-eye parallax image is projected by the first light to a projection area corresponding to the observer's left eye (i.e., a left-eye box), and the right-eye parallax image is projected by the second light to a projection area corresponding to the observer's right eye (i.e., a right-eye box). The timing of alternate display of the panel is synchronized with the timing of alternate projection of the light source modules. There is a full dark period between the first light and the second light, which corresponds to an image transformation delay of the backlit type display panel. The image switching interval for each eye is less than the human visual persistence time, so that the left eye of the observer feels watching the left-eye parallax image continuously, and the right eye feels watching the right-eye parallax image continuously, therefore a stereo image is presented in the observer's brain.

In some embodiment a directional backlit type dual image display device is disclosed, comprising a plurality of light source modules, at least two light source modules projecting a first light and a second light respectively, the reflective narrow-angle diffuser reflecting the first light and the second light, and uniformly diffusing the first light and the second light with a narrow diffusion angle respectively, a backlit type display panel alternately displaying a first image and a second image in a time-multiplexed manner. The first light source module and the second light source module alternately project the first light and the second light. When the first light and the second light pass through the backlit display panel, the first image is projected by the first light to a projection area corresponding to the first observer (i.e., a first eye box), and the second image is projected by the second light to a projection area corresponding to the second observer (i.e., a second eye box). The timing of alternate display of the panel is synchronized with the timing of alternate projection of the light source modules. There is a full dark period between the first light and the second light, which corresponds to an image transformation delay of the backlit type display panel. The image switching interval for each observer is less than the human visual persistence time, so that the first observer feels watching the first image continuously, the second observer feeling watching the second image continuously, and consequently the first observer and the second observer watch the first image and the second image simultaneously and respectively.

### BRIEF DESCRIPTION OF THE DRAWINGS

FIG. 1 is a schematic diagram of a TFT-LCD panel structure;

FIG. 2 is a schematic diagram of an ideal directional TFT-LCD;

FIG. 3A and FIG. 3B are schematic diagrams of a slit diffraction;

FIG. 4A and FIG. 4B are schematic diagrams of arrangement of pixels and RGB sub-pixels of the TFT-LCD panel;

FIG. 5A and FIG. 5B are schematic diagrams of the backlight of the backlit type display;

FIG. 6 is a schematic diagram of a backlight deployed with a collimated LED array;

FIG. 7 is a schematic diagram of the homogenization of a collimated LED array backlight of a backlit type display;

FIG. 8 is a schematic diagram of a reflective narrow-angle diffuser deployed in a projection image;

FIG. 9A and FIG. 9B are schematic diagrams of a structure of a reflective narrow-angle diffuser;

FIG. 10A, FIG. 10B, and FIG. 10C. are schematic diagrams of a projected light scattered on various reflection surfaces;

FIG. 11 is a schematic diagram of a projecting direction of a directional backlight of the first embodiment of the present disclosure;

FIG. 12A and FIG. 12B are schematic diagrams of a directional backlit type display device according to some embodiment of the present disclosure;

FIG. 13A, FIG. 13B, and FIG. 13C are schematic diagrams illustrating the position of the backlit type display panel of the present disclosure;

FIG. 14A, FIG. 14B, and FIG. 14C are a schematic diagrams of a directional backlit type autostereoscopic display device of the second embodiment of the present disclosure;

FIG. 15A and FIG. 15B are schematic diagrams according to some embodiment of the present disclosure;

FIG. 16A, FIG. 16B, and FIG. 16C. are schematic diagrams of a directional backlit type dual image display device of the third embodiment of the present disclosure;

FIG. 17A and FIG. 17B are schematic diagrams illustrating automotive application according to some embodiment of the present disclosure;

FIG. 18 is a schematic diagram of an eye box and a projection area of light source module;

FIG. 19 is a schematic diagram illustrating of the light projection area shaping of the present disclosure;

FIG. 20 is another schematic diagram illustrating of the light projection area shaping of the present disclosure;

FIG. 21 is a schematic diagram of a light source modules of the present disclosure;

FIG. 22A, FIG. 22B, FIG. 22C, FIG. 23A, FIG. 23B, FIG. 24, FIG. 25, FIG. 26, and FIG. 27 are schematic diagrams of the eye box configuration of the present disclosure.

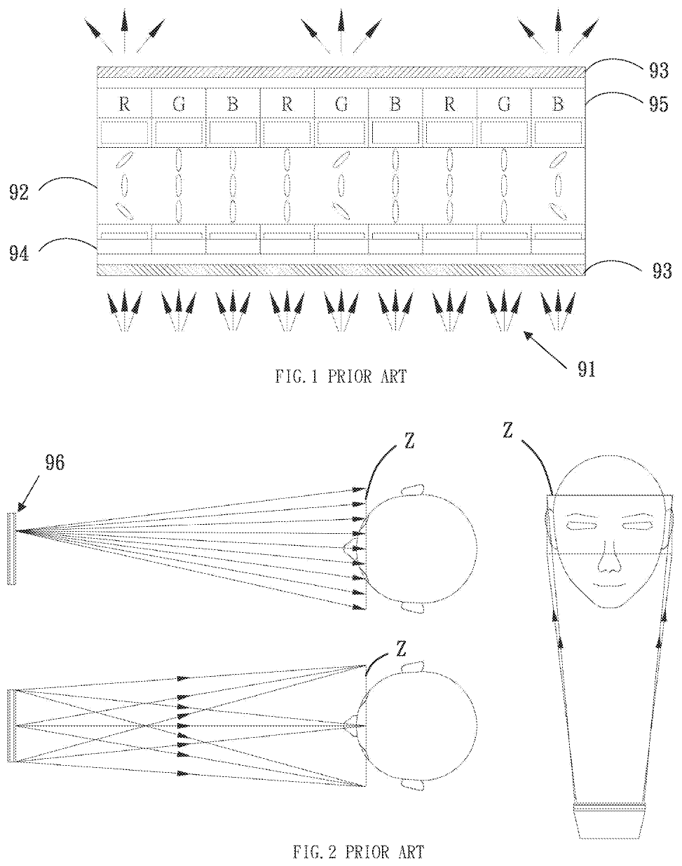

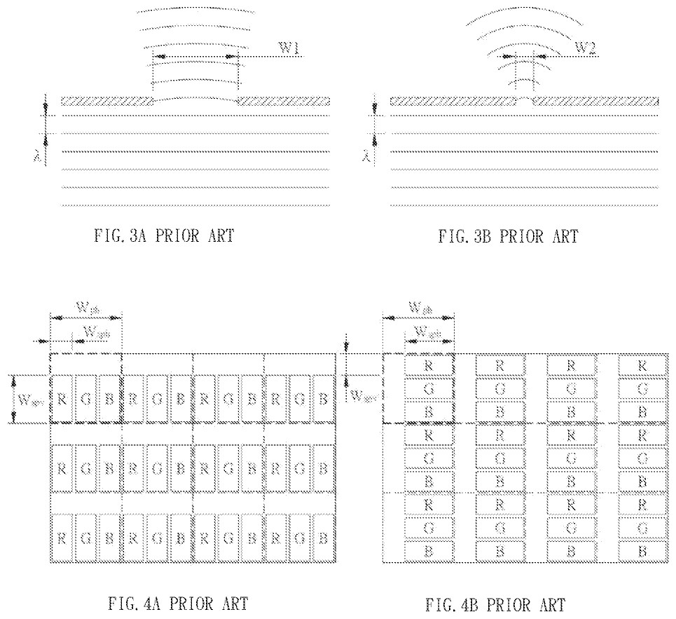

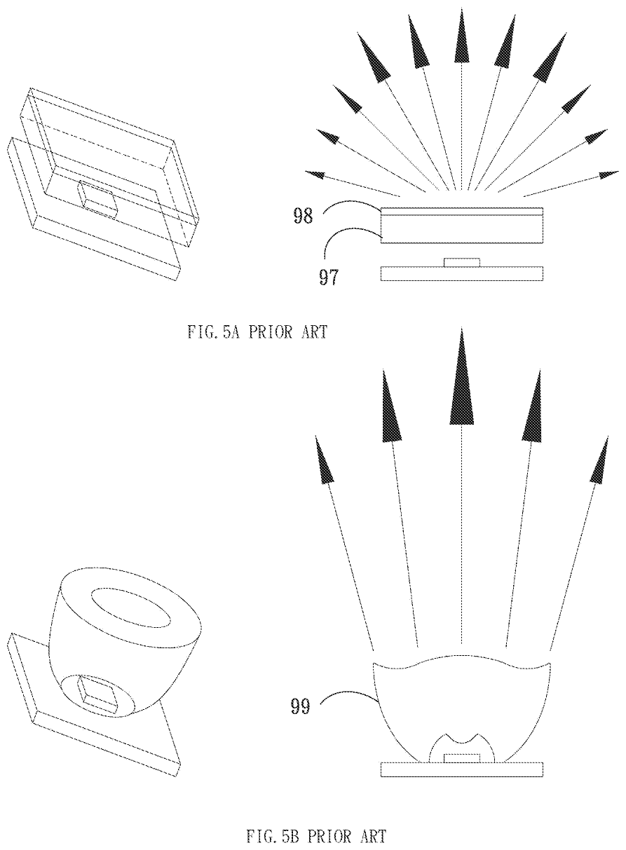

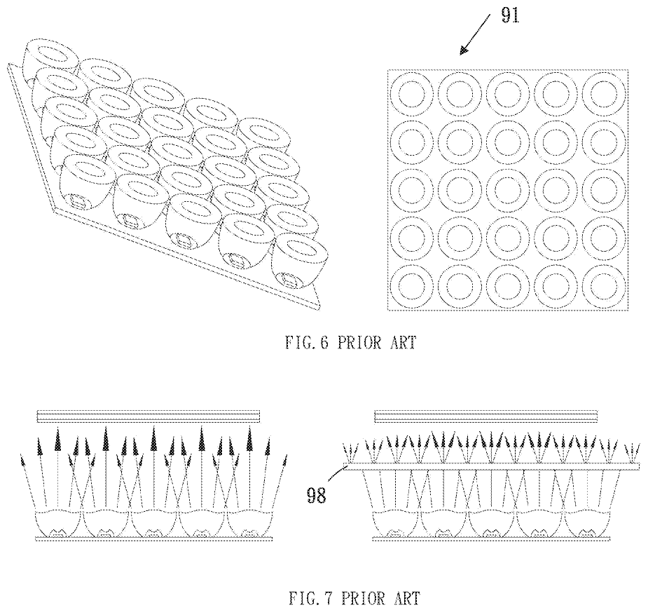

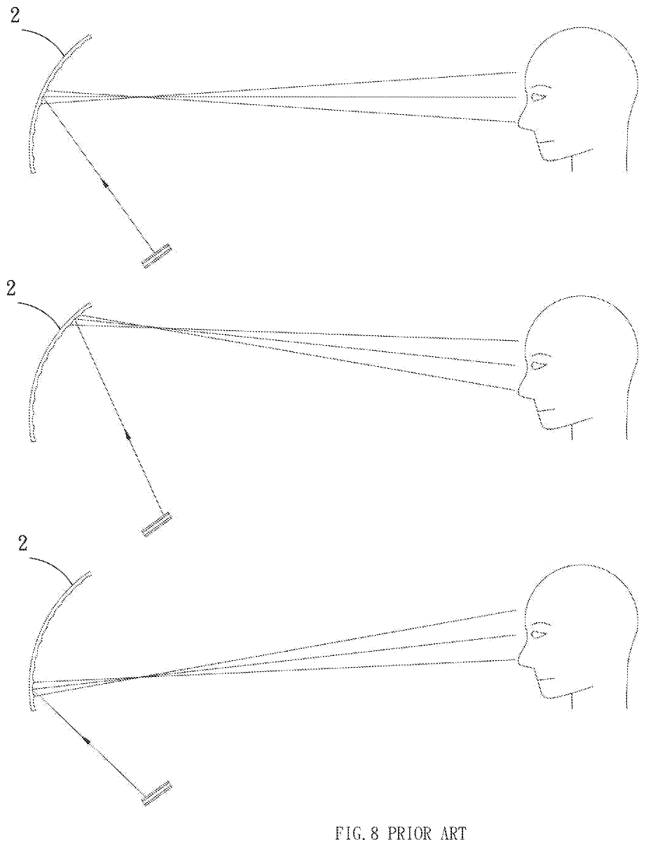

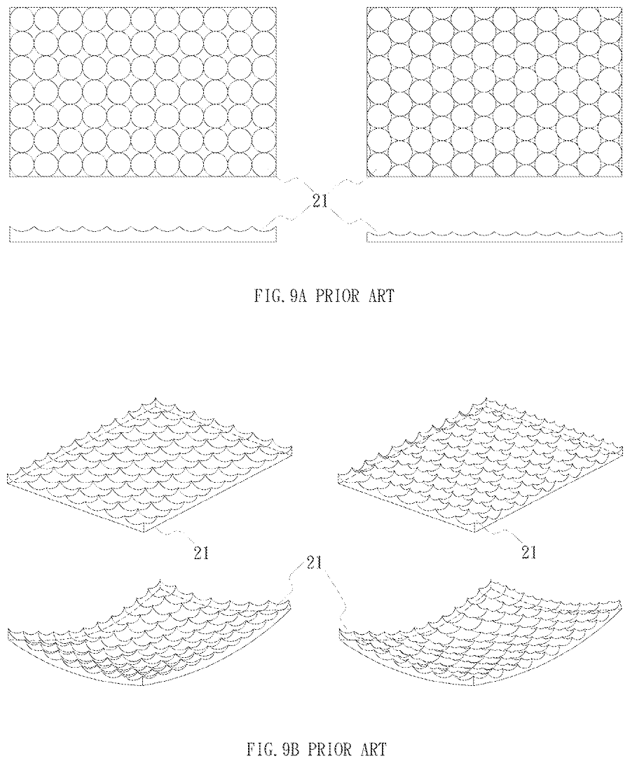

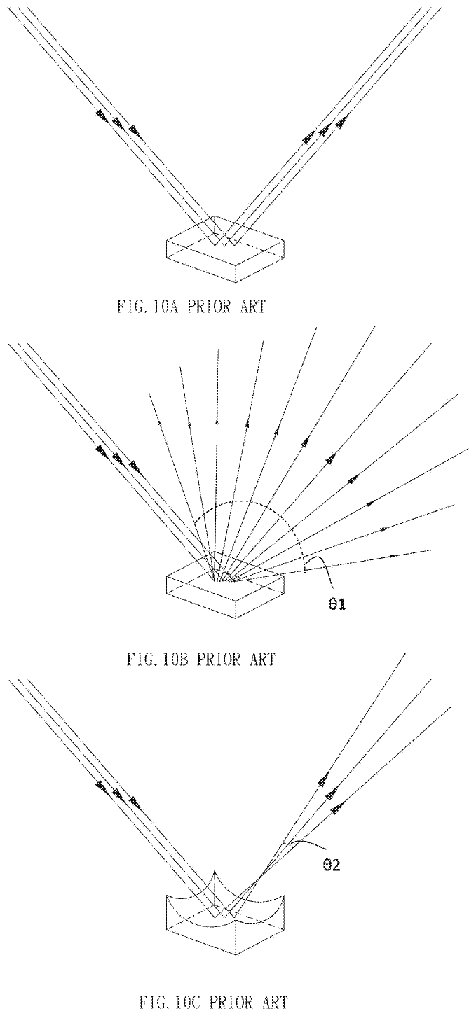

### DETAILED DESCRIPTION

A direction of a light projection is defined as front in the following description to meet common understandings of a person skilled in the art.

Please refer to FIG. 11-FIG. 13, the present disclosure provides an embodiment of a directional backlit type display device comprising the following.

A light source module 1 projects a light L.

A reflective narrow-angle diffuser 2 comprises a plurality of micro-concave mirrors 21 laid out in an array. The reflective narrow-angle diffuser 2 reflects the light L and uniformly diffuses the light L with a narrow diffusion angle. In other words, each micro-concave mirror 21 reflects the light L, and the reflected light L being oriented to a preset direction projecting a light diffusion area. In some embodiment, the micro-concave mirrors 21 are also changed to micro-convex mirrors or other forms of micro-curved mirrors.

Please refer to FIG. 11, the light source module 1 projects the light L onto the reflective narrow-angle diffuser 2, and a plurality of micro-concave mirrors 21 reflect the light toward a preset direction and diffuse the light with a narrow diffusion angle to generate a directional light beam with uniform brightness.

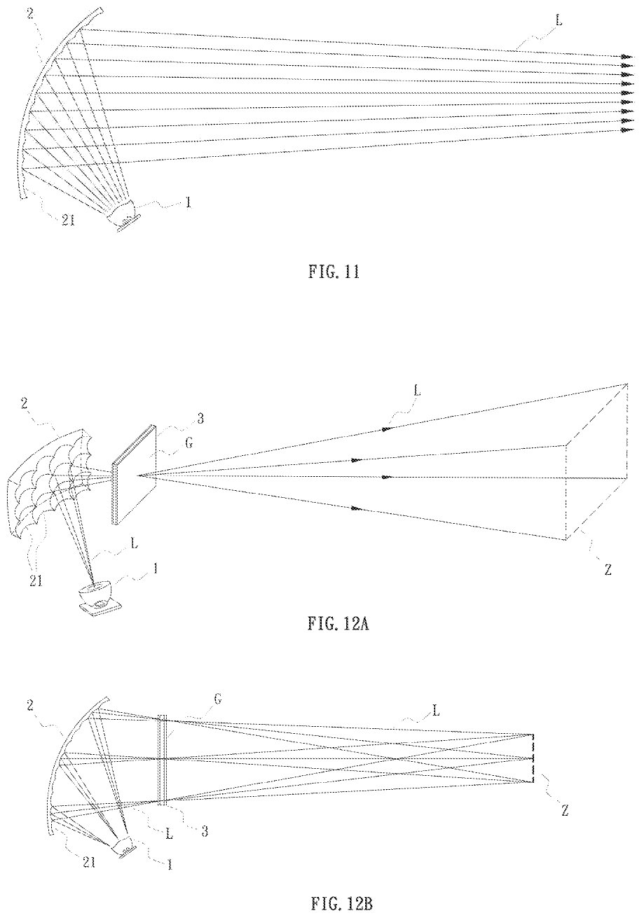

Please refer to FIG. 12A, a TFT-LCD panel 3 is placed on a projecting path where the reflective narrow-angle diffuser 2 projects the light L to an observer. An image G displayed on the TFT-LCD panel 3 is projected to a projection area (i.e., an eye box Z of the observer) by the light L. Each pixel of the image G is corresponded to at least one of the micro-concave mirrors 21 on the reflective narrow-angle diffuser 2, as shown in FIG. 12B. The light passing through each pixel is uniformly diffused to the eye box Z. Light projection angle and diffusion angle corresponding to each pixel of the image G is adjusted by the reflective narrow-angle diffuser to superimpose all the diffusion areas on the same projection area under the design distance. Hundreds of thousands and millions of pixels on the TFT-LCD panel all have the same diffusion situation. Please refer to FIG. 4B, the sub-pixels of each pixel on the TFT-LCD panel 3, such as RGB sub-pixels, are arranged with the long edges of sub-pixels perpendicular to the up-down direction of the display panel to increase the horizontal width Wₛₚₕ of each sub-pixel and reduce the diffraction phenomenon in the horizontal direction to prevent others beside from seeing the image.

In this situation, the observer sees the full image G while eyes of the observer are in any position within the eye box Z. On the other hand, the observer can't see any image G at all while eyes of the observer are outside of the eye box Z.

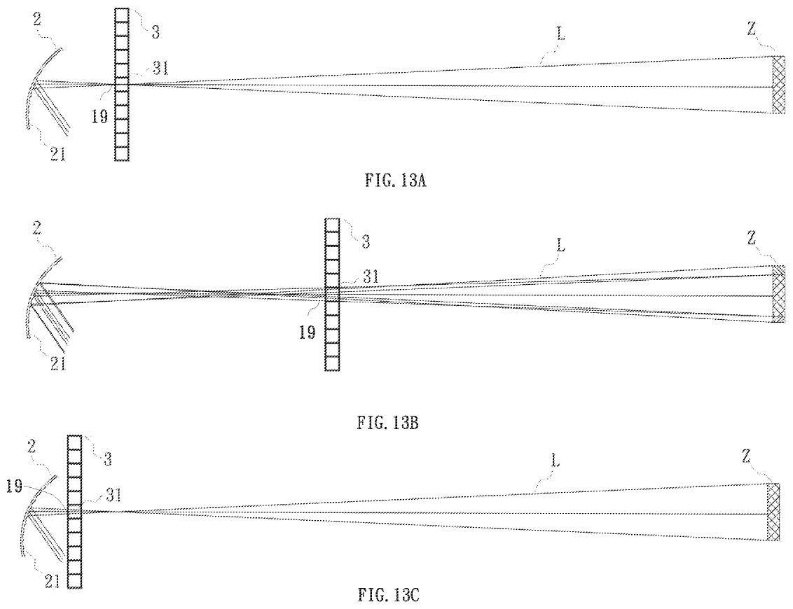

The size of any micro-concave mirror 21 of the reflective narrow-angle diffuser 2 is smaller than or equal to any pixel 31 of the image G. The reflective narrow-angle diffuser 2 is configured to define sizes, brightness, and location of the projection area Z. Please refer to FIG. 13A, when the TFT-LCD panel 3 is placed on the focal length of the micro-concave mirrors 21 of the reflective narrow-angle diffuser 2, meanwhile one pixel 31 of the image G is greater than or equal to a light diffusion area 19 here. The light L projected by a single micro-concave mirror 21 through the pixel 31 can diffuse to the entire eye box Z. Please refer to FIG. 13B, when the TFT-LCD panel 3 is placed at a distance greater than the focal length of the micro-concave mirrors 21, meanwhile one pixel 31 of the image G is smaller than the light diffusion area 19 of the micro-concave mirror 21 here, so it is projected with multiple micro-concave mirrors 21, therefore the light L of the pixel 31 is diffused to the entire eye box Z. Please refer to FIG. 13C, when the TFT-LCD panel 3 is placed less than the focal length of the micro-concave mirrors 21, meanwhile one pixel 31 of the image G is greater than the light diffusion area 19 of the micro-concave mirror here. The light L projected by a single micro-concave mirror 21 through the pixel 31 is diffused to the entire eye box Z. Similarly, even if the light diffusion area 19 of light L projected to the image G by a single micro-concave mirror 21 corresponds to multiple pixels, the above effectiveness can be achieved as long as the image G is within the range of the reflected light beam of the reflective diffuser. Hence, the position of the TFT-LCD panel 3 can be set at any position on the optical path (the reflection path) between the reflective narrow-angle diffuser 2 and the eye box Z of the observer.

For a backlight deployed in a non-directional backlit type display device, if the field directivity of the electromagnetic wave energy is used to define the directivity of the light field of the backlight, the FWHM (Full Width at Half Maximum) is about ±30˜±60° or wider, thereby the projected image has a wider viewing angle.

The backlight of the directional backlit type display device in the present disclosure as shown in FIG. 11-FIG. 13, the FWHM of the light field of the backlight is about ±5˜±10° or narrower, that is, the narrow-diffusion angle is about ±5˜±10° or narrower, thereby the projected image having a narrower viewing angle. However, it is not limited to define a specific angle of the narrow-diffusion angle using other modes in the present disclosure.

The directional backlit type display device of the present disclosure further comprises a concave mirror and a windshield arranged on the optical path of the light in front of the backlit type display panel. The light carrying the image is reflected and magnified by the concave mirror and the windshield, and finally projected to the eye box Z of the observer.

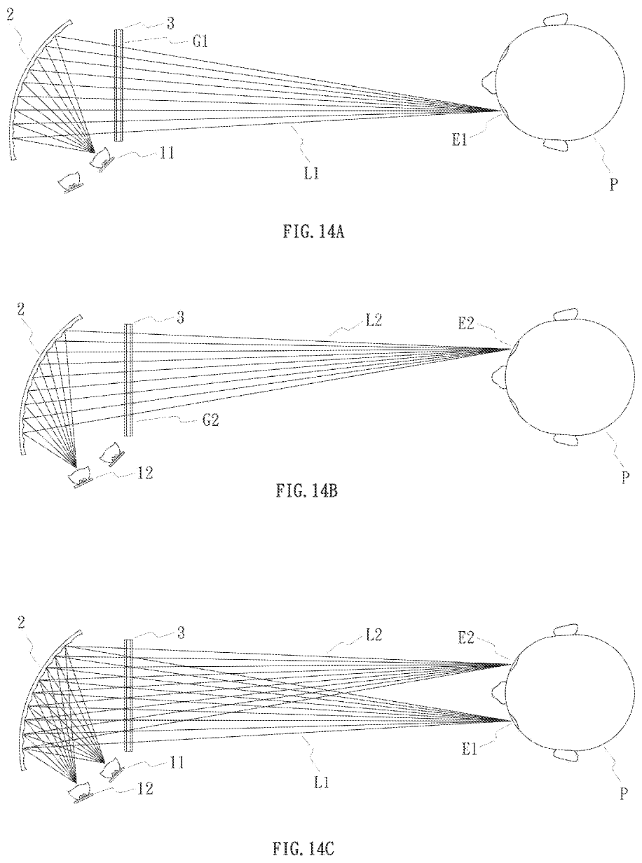

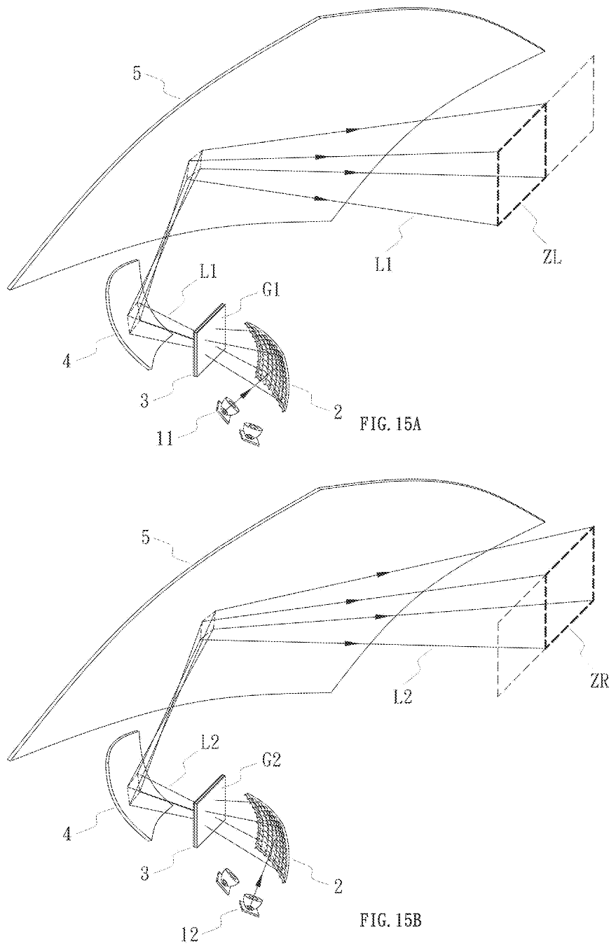

Please refer to FIG. 14A, FIG. 14B, and FIG. 14C, the present disclosure provides an embodiment of a directional backlit type display device forming an autostereoscopic image comprising the following.

A first light source module 11 projects a first light L1.

A second light source module 12 projects a second light L2.

A reflective narrow-angle diffuser 2 comprises a plurality of micro-concave mirrors 21 laid out in an array. The reflective narrow-angle diffuser 2 reflects the first light L1 and the second light L2 and uniformly diffuses the first light L1 and the second light L2 with a narrow diffusion angle respectively.

A TFT-LCD panel 3 is placed on a projecting path where the reflective narrow-angle diffuser 2 projects the first light L1 and the second light L2 to the observer P. The TFT-LCD panel 3 alternately displays a left-eye parallax image G1 and a right-eye parallax image G2 in a time-multiplexed manner. The first light source module 11 and the second light source module 12 alternately project the first light L1 and the second light L2. Please refer to FIG. 14A, the first light L1 projects the left-eye parallax image G1 to a projection area of a left eye E1 of the observer P (i.e., a left-eye box ZL as shown in FIG. 15A). Please refer to FIG. 14B, the second light L2 projects the right-eye parallax image G2 to a projection area of a right eye E2 of the observer P (i.e., a right-eye box ZR as shown in FIG. 15B). The timing of projecting the first light L1 and the second light L2 is synchronized with the timing of displaying the left-eye parallax image G1 and the right-eye parallax image G2. There is a full dark period between the first light L1 and the second light L2, which corresponds to an image transformation delay of the TFT-LCD panel 3. The image switching interval for each eye is less than the human visual persistence time, which is about 1/15˜ 1/60 seconds. For example, the left-eye image and the right-eye image are displayed alternately at a frequency of 120 Hz, so that the left eye frame rate (FPS) is 60 Hz, and the right eye frame rate (FPS) is 60 Hz, therefore the observer P wouldn't notice image flickering. As shown in FIG. 14C, a single TFT-LCD panel 3 can be used to allow the left eye of the observer P watching the left-eye parallax image G1 while also allowing the right eye of the observer P watching the right-eye parallax image G2, forming a stereoscopic image in the observer P's brain. Reasonably, the higher frequency alternately the left-eye image and the right-eye image are displayed, such as 144 Hz and 240 Hz, the smoother the image is.

Please refer to FIG. 4B, the color sub-pixel (Sub-Pixel) of each pixel (Pixel) on the TFT-LCD panel, such as the red, green, and blue (RGB) sub-pixels, is arranged with the long edge of each sub-pixel perpendicular to the vertical direction of the TFT-LCD panel, increasing the horizontal width Wₛₚₕ of each sub-pixel, reducing the diffraction phenomenon in the horizontal direction, and preventing the left eye from seeing the right-eye parallax image or the right eye from seeing the left-eye parallax image.

The left-eye parallax image G1 and the right-eye parallax image G2 can be placed on the same area or different areas on the TFT-LCD panel 3, and the left-eye parallax image G1 and the right-eye parallax image G2 are the same size or different sizes.

Please refer to FIG. 15A, the directional backlit type display device of the present disclosure further includes a concave mirror 4 and a windshield 5. The first light L1 carrying the left-eye parallax image G1 is reflected and magnified by the concave mirror 4 and the windshield 5, and finally projected to the projection area of the left-eye box ZL corresponding to the observer. Please refer to FIG. 15B, the second light L2 carrying the right-eye parallax image G2 is reflected and magnified by the concave mirror 4 and the windshield 5, and finally projected to the projection area of the right-eye box ZR corresponding to the observer.

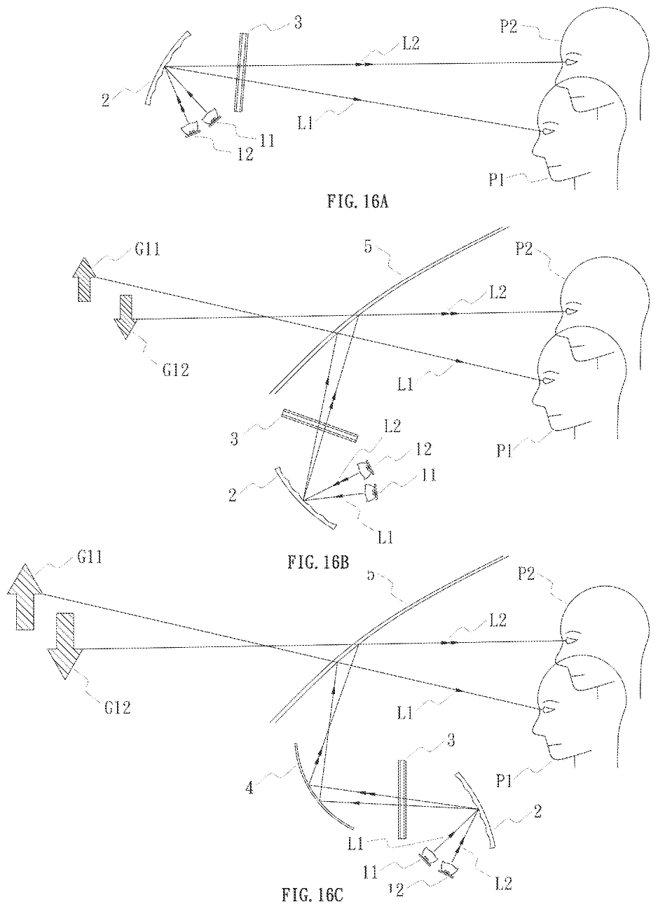

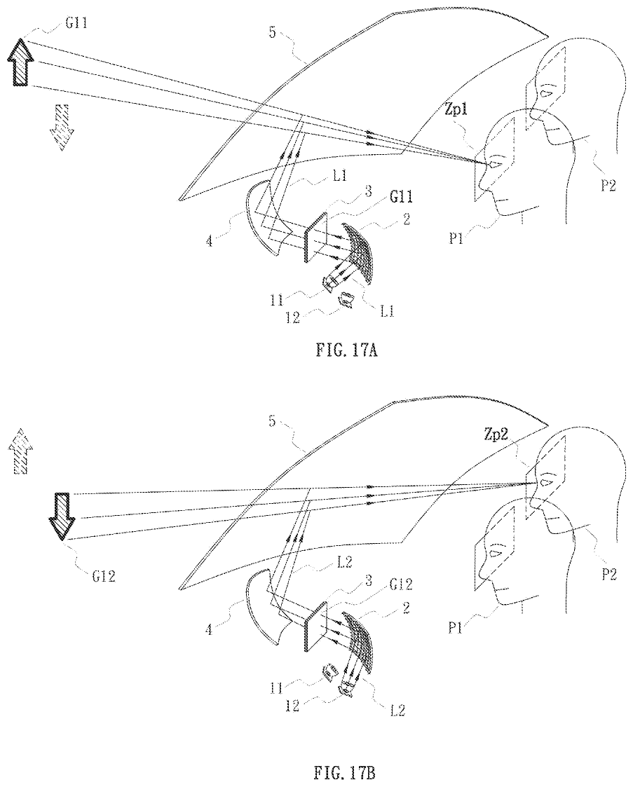

Please refer to FIG. 16A, FIG. 16B, and FIG. 16C, the present disclosure provides an embodiment of a directional backlit type display device forming a dual image comprising the following.

A first light source module 11 projects a first light L1.

A second light source module 12 projects a second light L2.

A reflective narrow-angle diffuser 2 comprises a plurality of micro-concave mirrors 21 laid out in an array. The reflective narrow-angle diffuser 2 reflects the first light L1 and the second light L2, and uniformly diffuses the first light L1 and the second light L2 with a narrow diffusion angle respectively.

A TFT-LCD panel 3 is placed on a projecting path where the reflective narrow-angle diffuser 2 projects the first light L1 and the second light L2 to a first observer P1 and a second observer P2. The TFT-LCD panel 3 alternately displays a first image G11 and a second image G12 in a time-multiplexed manner. The first light source module 11 and the second light source module 12 alternately project the first light L1 and the second light L2. The first light L1 projects the first image G11 to a projection area of eyes of the first observer P1 (i.e., a first eye box Zp1 as shown in FIG. 17A). The second light L2 projects the second image G12 to a projection area of eyes of the second observer P2 (i.e., a second eye box Zp2 as shown in FIG. 17B). The timing of projecting the first light L1 and the second light L2 is synchronized with the timing of displaying the first image G11 and the second image G12. There is a full dark period between the first light L1 and the second light L2, which corresponds to an image transformation delay of the TFT-LCD panel 3. The image switching interval for each observer is less than the human visual persistence time, therefore the observers wouldn't notice image flickering. A single TFT-LCD panel 3 is used to allow the first observer P1 to watch the first image G11 while also allowing the second observer P2 to watch the second image G12. The first observer P1 cannot see the second image G12, and the second observer P2 cannot see the first image G11.

Please refer to FIG. 4B, the color sub-pixel (Sub-Pixel) of each pixel (Pixel) on the TFT-LCD panel, such as the red, green, and blue (RGB) sub-pixels, is arranged with the long edge of each sub-pixel perpendicular to the vertical direction of the TFT-LCD panel, increasing the horizontal width Wₛₚₕ of each sub-pixel, reducing the diffraction phenomenon in the horizontal direction, and preventing the first observer from seeing the second image or the second observer from seeing the first image.

Please refer to FIG. 16B, the directional backlit type display device of the present disclosure further includes a windshield 5 arranged between the optical path of the first light L1 and the second light L2 travelling from the TFT-LCD panel 3 to the first observer P1 and the second observer P2. The first light L1 carrying the first image G11 is projected to the windshield 5, and then reflected by the windshield 5, and finally projected to the first eye box Zp1 of the first observer's P1 eyes (as shown in FIG. 17A). The second light L2 carrying the second image G12 is projected to the windshield 5, and then reflected by the windshield 5, and finally projected to the second eye box Zp2 of the second observer's P2 eyes (as shown in FIG. 17B), which allows the first observer P1 to watch the first image G11 while also allowing the second observer P2 to watch the second image G12, and the first observer P1 cannot see the second image G12, and the second observer P2 cannot see the first image G11.

Please refer to FIG. 16C, the directional backlit type display device of the present disclosure compared to the embodiment as shown in FIG. 16B, further comprises a concave mirror 4 configured between the TFT-LCD panel 3 and the windshield 5. Please refer to FIG. 17A, the first light L1 carrying the first image G11 is projected to the concave mirror 4, is reflected and magnified by the concave mirror 4, and then projected to the windshield 5, reflected by the windshield 5, and finally projected to the first eye box Zp1 of the first observer P1's eyes. Please refer to FIG. 17B, the second light L2 carrying the second image G12 is projected to the concave mirror 4, is reflected and magnified by the concave mirror 4, and then projected to the windshield 5, reflected by the windshield 5 and finally projected to the second eye box Zp2 of the second observer P2′ eyes, which allows the first observer P1 to watch the first image G11 while also allowing the second observer P2 to watch the second image G12, and the first observer P1 cannot see the second image G12, and the second observer P2 can not to see the first image G11.

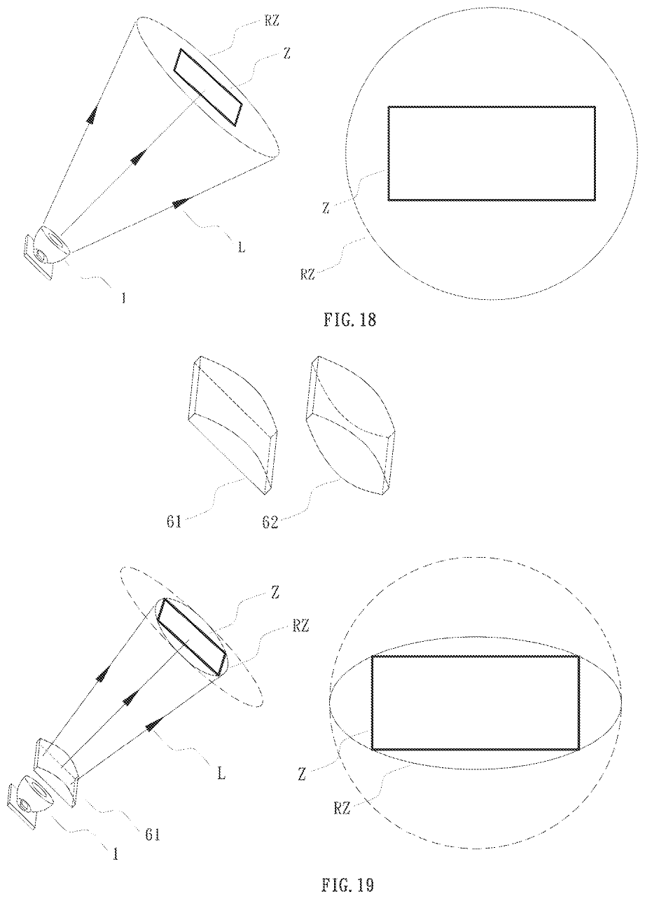

Please refer to FIG. 18, in general, the final projection area (i.e., the eye box Z) produced by the light source module is usually designed as a rectangular shape, but the projection area RZ formed by the light L is not a rectangular shape. In fact, the projection area RZ is usually a circular shape, causing a part of the light L outside of the eye box Z being wasted on the optical path.

Please refer to FIG. 19, to increase the brightness of the image and improve the utilization of light projected, the above embodiment further include a plano-convex cylindrical lens 61 or a biconvex cylindrical lens 62 between the reflective narrow-angle diffuser 2 and the light source module 1 to shape the circular projection area RZ of the light source module 1 into an elliptical shape, which is similar to a rectangular eye box.

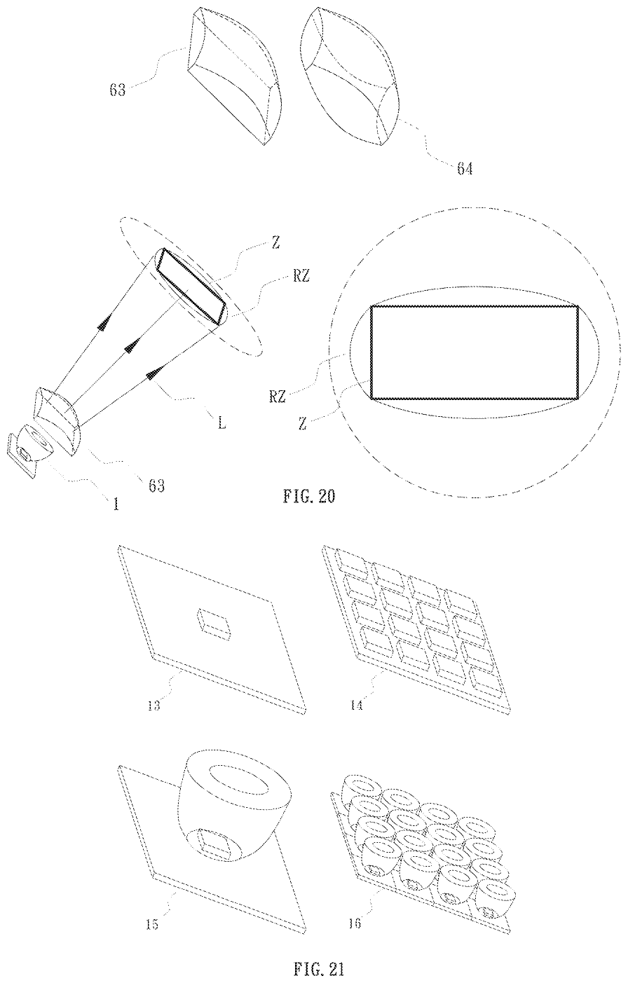

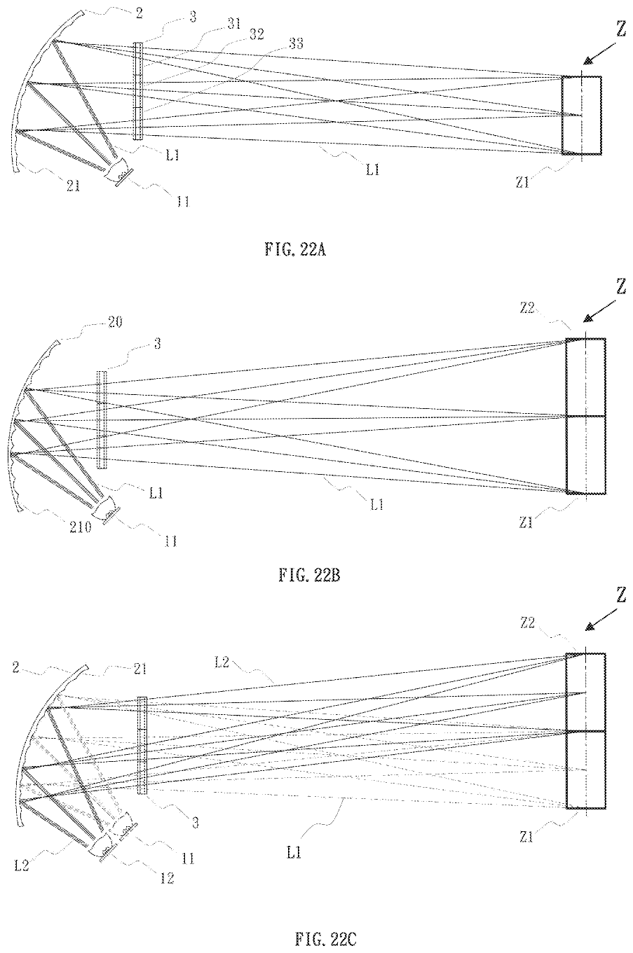

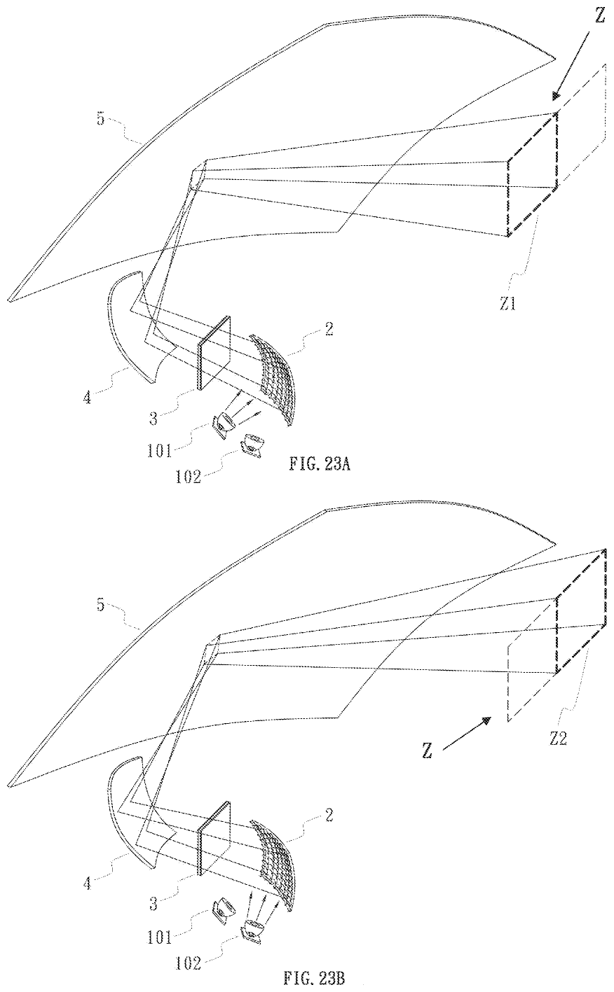

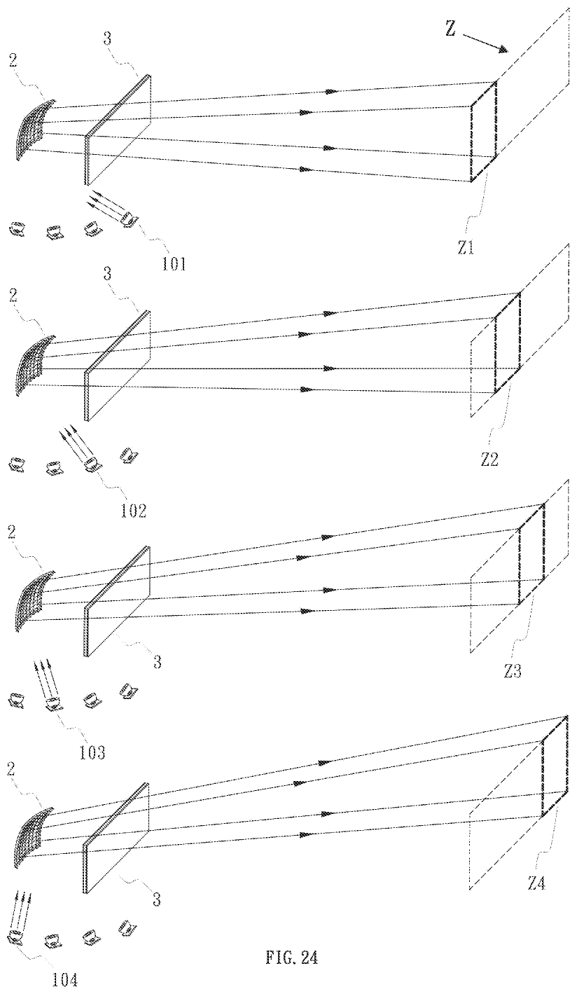

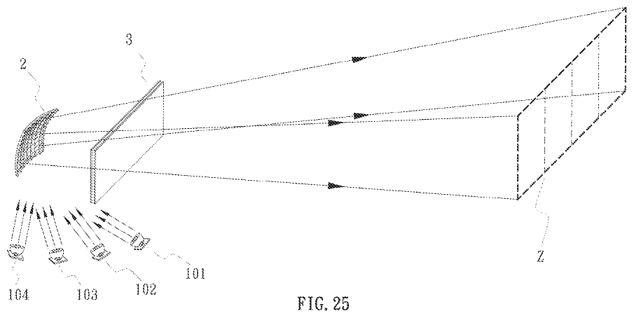

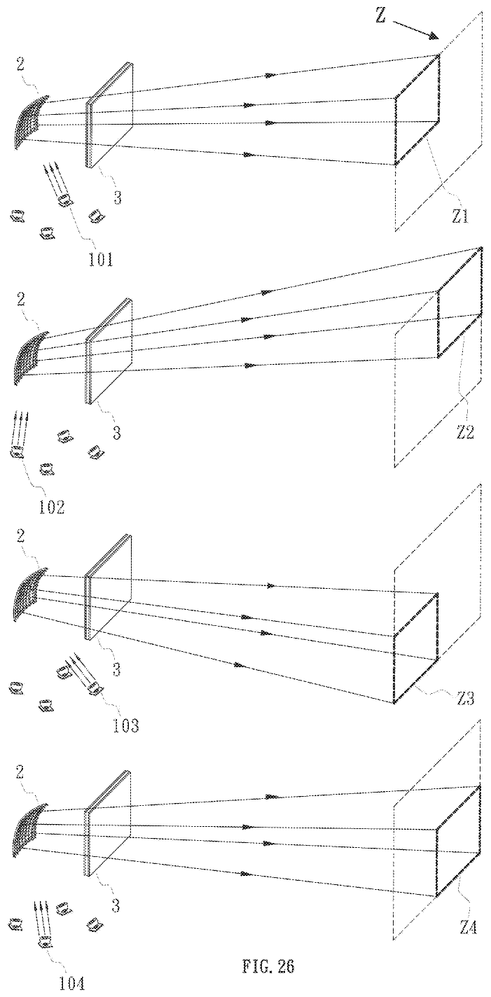

Please refer to FIG. 20, to increase the brightness of the image and improve the utilization of light projected, the above embodiment further include a plano-convex lens 63 or a biconvex lens 64 between the reflective narrow-angle diffuser 2 and the light source module 1, that is, lenses with curvature in both axial directions, to shape the circular projection area RZ of the light source module 1 into an approximate rectangular shape, which is more similar to a rectangular eye box.

In addition, at least a reflector is included between the reflective narrow-angle diffuser and the light source module to fold the optical path and make the use of space more flexible.

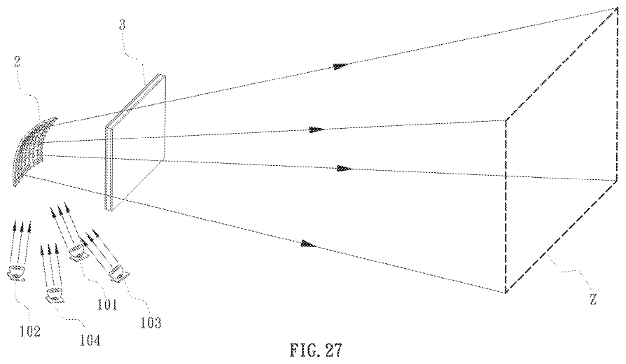

Please refer to FIG. 21, in some embodiment, the first light source module 11 and the second light source module 12 are a high power LED 13, an LED array 14, an LED with collimating lens 15, or a collimated LED lens array 16. These light source modules are capable of forming a directional light after the light being reflected by the reflective narrow-angle diffuser 2.

Please refer to FIG. 22A-FIG. 27, the embodiment of the present disclosure further explains how the sizes, brightness and location of the projection area are designed or adjusted.

Please refer to FIG. 22A, the first light module 11 projects the first light L1 to the reflective narrow-angle diffuser 2. The TFT-LCD panel 3 has three pixels 31, 32, 33. The light source L1 is reflected and diffused by the micro-concave mirrors 21 array on the reflective narrow-angle diffuser 2 and then penetrates the three pixels 31, 32, 33 of the TFT-LCD panel 3, and then projected and diffused to a first projection area Z1. In the embodiment of the present disclosure, the size of the first projection area Z1 is the size of the eye box Z. As long as the eyes are within the range of the first projection area Z1, the observer sees the identical three pixels 31, 32, 33 of the TFT-LCD panel 3. Based on the size of the first projection area Z1 as shown in FIG. 22A, a double-width projection area eye box Z (i.e., the first projection area Z1 added with a second projection area Z2) is deployed as illustrated in FIG. 22B. Compared with the embodiment as shown in FIG. 22A, the embodiment as shown in FIG. 22B is a reflective narrow-angle diffuser 20 using an array of micro-concave mirrors 210 with different curvatures and angles. The first light L1 is reflected and diffused by the reflective narrow-angle diffuser 2 and penetrates the three pixels 31, 32, 33 of the TFT-LCD panel 3, and then is projected and diffused to the eye box Z formed by the first projection area Z1 and the second projection area Z2. As long as the eyes of the observer are within the range of the first projection area Z1 and the second projection area Z2, the observer sees the identical three pixels 31, 32, 33 of the TFT-LCD panel 3. However, this method is equivalent to dispersing the first light L1 to the range of the eye box Z, which will reduce the brightness of the viewed image by half.

Based on the size of the first projection area Z1, a double-width eye box Z is deployed as illustrated in FIG. 22C. In some embodiment, a reflective narrow-angle diffuser uses micro-concave mirrors array 210 with the same curvature and angle as illustrated in FIG. 22A, moreover, a first light source module 11 and a second light source module 12 are used at the same time. The first light source module 11 projects a first light L1 to the reflective narrow-angle diffuser 2. The first light L1 is reflected and diffused by the array of the micro-concave mirrors 21 on the reflective narrow-angle diffuser 2, and then penetrates the three pixels 31, 32, 33 of the TFT-LCD panel 3, and then projected and diffused to the first projection area Z1 of the eye box Z. The second light source module 12 projects a second light L2 to the reflective narrow-angle diffuser 2. The second light L2 is reflected and diffused by the array of the micro-concave mirrors 21 on the reflective narrow-angle diffuser 2, and then penetrates the three pixels 31, 32, 33 of the TFT-LCD panel 3, and then projected and diffused to the second projection area Z2 of the eye box Z. In this way, as long as the eyes are within the range of the first projection area Z1 and the second projection area Z2, the observer sees the same three pixels 31, 32, 33 of the TFT-LCD panel 3, and the image brightness is the same as illustrated in the embodiment of FIG. 22A, and the brightness will not be halved because the size of the eye box Z is doubled.

Using multiple light source modules for the same reflective narrow-angle diffuser is to add multiple incident light rays of different angles. Each light source module will diffuse at different angles. Therefore, the smaller the area of the light source, the smaller the diffused area of the eye box, and the larger the area of the light source, the larger the diffused area of the eye box.

In the embodiment shown in FIG. 23A and FIG. 23B, the range of the eye box Z is composed of the first projection area Z1 and the second projection area Z2 of the same size. Each projection area Z1, Z2 is produced by a separate light source module. For example, two projection areas Z1, Z2 are arranged side by side to form the eye box Z. A first light source module 101 corresponds to the first projection area Z1, and a second light source module 102 corresponds to the second projection area Z2. As long as the eyes are within this eye box Z, the observer sees the same image. When the first light source module 101 and the second light source module 102 project light simultaneously, it is equivalent to have the brightness of two light sources in the eye box Z.

In the embodiment shown in FIG. 24, the eye box Z is formed by arranging four projection areas side by side, a first light source module 101 correspondingly forming a first projection area Z1, and a second light source module 102 correspondingly forming a second projection area Z2, and a third light source module 103 correspondingly forming a third projection area Z3, and a fourth light source module 104 correspondingly forming a fourth projection area Z4. As shown in FIG. 25, when the first light source module 101, the second light source module 102, the third light source module 103, and the fourth light source module 104 project light simultaneously, it is equivalent to have the brightness of four light sources in the long eye box Z. As long as the eyes are within the eye box Z, the observer sees the same image.

In some embodiment shown in FIG. 26, the eye box Z is formed by arranging four projection areas in a matrix, a first light source module 101 correspondingly forming a first projection area Z1, and a second light source module 102 correspondingly forming a second projection area Z2, and a third light source module 103 correspondingly forming a third projection area Z3, and a fourth light source module 104 correspondingly forming a fourth projection area Z4. As shown in FIG. 27, when the first light source module 101, the second light source module 102, the third light source module 103, and the fourth light source module 104 project light simultaneously, it is equivalent to have the brightness of four light sources in the matrix eye box Z.

The combination and arrangement of the projection area forming the size of the eye box is not limited to the examples of the above. Changes can be made according to various demands.

What is claimed is:

1. A directional backlit type display device comprising:
a light source module, being configure to project a light;
a reflective narrow-angle diffuser, having a plurality of micro-curved mirrors laid out in an array; wherein the reflective narrow-angle diffuser is configured to reflect the light and uniformly diffuse the light with a narrow diffusion angle;
a backlit type display panel, being configured to display an image;
wherein the light reflected by the reflective narrow-angle diffuser projects the image on the backlit type display panel to a projection area;
wherein each pixel of the image is corresponded to at least one of the micro-curved mirrors of the reflective narrow-angle diffuser, enabling all pixels of the image to be uniformly diffused into the projection area.

2. The directional backlit type display device of claim 1, wherein the back-lit display panel comprises each pixel with sub-pixels, wherein the long edge of each sub-pixel is perpendicular to a vertical direction of the backlit type display panel.

3. The directional backlit type display device of claim 1, wherein the reflective narrow-angle diffuser and the light source module comprise a plano-convex cylindrical lens or a biconvex cylindrical lens configured therebetween, shaping a circular projection light area of the light source module into an elliptical shape.

4. The directional backlit type display device of claim 1, wherein the reflective narrow-angle diffuser and the light source module comprise a plano-convex lens or a biconvex lens configured therebetween, shaping a circular projection light area of the light source module into a closed shape around a rectangle.

5. The directional backlit type display device of claim 1, wherein the light source module is a high power LED or an LED array or an LED with collimating lens or a collimated LED array.

6. The directional backlit type display device of claim 1, wherein a windshield is configured on an optical path to project the image to the projection area.

7. The directional backlit type display device of claim 1, wherein a concave mirror is configured on an optical path to project the image to the projection area.

8. The directional backlit type display device of claim 1, wherein the reflective narrow-angle diffuser is configured to define sizes, brightness, and location of the projection area.

9. The directional backlit type display device of claim 1, wherein the light source module is configured to define sizes, brightness, and location of the projection area.

10. The directional backlit type display device of claim 1, wherein the reflective narrow-angle diffuser and the light source module comprise at least a reflector configured therebetween.

11. The directional backlit type display device of claim 1, comprising a plurality of light source modules, wherein at least two of the light source modules project a first light and a second light respectively, the reflective narrow-angle diffuser reflecting and uniformly diffusing the first light and the second light with the narrow diffusion angle respectively, the backlit type display panel being configured to display the image, wherein the first light and the second light individually reflected by the reflective narrow-angle diffuser project the image on the backlit type display panel to define two projection areas;

12. The directional backlit type display device of claim 11, wherein a part of the image displayed by the backlit display panel is a left-eye parallax image, and the other part is a right-eye parallax image.

13. The directional backlit type display device of claim 11, wherein the backlit type display panel alternately displays a left-eye parallax image and a right-eye parallax image in a time-multiplexed manner, the light source modules alternately projecting the first light and the second light, the projection of the first light and the second light synchronizing with the display timing of the left-eye parallax image and the right-eye parallax image, a full dark period between the first light and the second light corresponding to an image transformation delay of the backlit type display panel, an image switching interval for each eye being less than a human visual persistence time.

14. The directional backlit type display device of claim 11, wherein a part of the image displayed by the backlit display panel is a first binocular image, and the other part is a second binocular image.

15. The directional backlit type display device of claim 11, wherein the backlit type display panel alternately displays the first binocular image and the second binocular image in a time-multiplexed manner, the light source modules alternately projecting the first light and the second light, the projection of the first light and the second light synchronizing with the display timing of the first binocular image and the second binocular image, a full dark period between the first light and the second light corresponding to an image transformation delay of the backlit type display panel, an image switching interval for eyes being less than a human visual persistence time.
